(19) United States
(12) Patent Application Publication
(10) Pub. No.: US 2009/0050601 A1
(43) Pub. Date: Feb. 26, 2009

(54) INERT GAS ETCHING

(75) Inventors: Youngbae Park, Milpitas, CA (US); Liangbing Hu, Mountain View, CA (US)

Correspondence Address: UNIDYM, 201 SOUTH LAKE AVE., SUITE 703, PASADENA, CA, 91101, US

(73) Assignee: UNIDYM, INC., Menlo Park, CA (US)

(21) Appl. No.: 12/197,457

(22) Filed: Aug. 25, 2008

Related U.S. Application Data
(60) Provisional application No. 60/957,531, filed on Aug. 23, 2007.

(51) Int. Cl. H01B 13/00

(52) U.S. Cl. 216/13; 977/847

(57) ABSTRACT

A method of patterning a nanostructure film using a plasma is described. The nanostructure film may substantially comprise carbon and/or carbon nanotubes. The plasma may comprise an inert gas. The plasma may be applied to the nanostructure film at close to atmospheric pressure and room temperature.

### FIELD OF THE INVENTION

This application claims priority to U.S. Provisional Patent Application No. 60/957,531, filed Aug. 23, 2007 and entitled “INERT GAS ETCHING,” the entire contents of which are incorporated herein by reference.

### FIELD OF THE INVENTION

The present invention relates generally to nanostructure films, and more specifically to patterning methods thereof.

### BACKGROUND OF THE INVENTION

Many modern and/or emerging applications require at least one device electrode that has not only high electrical conductivity, but high optical transparency as well. Such applications include, but are not limited to, touch screens (e.g., analog, resistive, 4-wire resistive, 5-wire resistive, surface capacitive, projected capacitive, multi-touch, etc.), displays (e.g., flexible, rigid, electro-phoretic, electro-luminescent, electrochromatic, liquid crystal (LCD), plasma (PDP), organic light emitting diode (OLED), etc.), solar cells (e.g., silicon (amorphous, protocrystalline, nanocrystalline), cadmium telluride (CdTe), copper indium gallium selenide (CIGS), copper indium selenide (CIS), gallium arsenide (GaAs), light absorbing dyes, quantum dots, organic semiconductors (e.g., polymers, small-molecule compounds)), solid state lighting, fiber-optic communications (e.g., electro-optic and opto-electric modulators) and microfluidics (e.g., electrowetting on dielectric (EWOD)). Many such applications additionally require that the optically transparent and electrically conductive electrode be patterned, such that certain portions thereof have different electrical and/or optical properties than other portions.

As used herein, a layer of material or a sequence of several layers of different materials is said to be “transparent” when the layer or layers permit at least 50% of the ambient electromagnetic radiation in relevant wavelengths to be transmitted through the layer or layers. Similarly, layers which permit some but less than 50% transmission of ambient electromagnetic radiation in relevant wavelengths are said to be “semi-transparent.”

Currently, the most common transparent electrodes are transparent conducting oxides (TCOs), specifically indium-tin-oxide (ITO) on glass. However, ITO can be an inadequate solution for many of the above-mentioned applications (e.g., due to its relatively brittle nature, correspondingly inferior flexibility and abrasion resistance), and the indium component of ITO is rapidly becoming a scarce commodity. Additionally, ITO deposition usually requires expensive, high-temperature sputtering, which can be incompatible with many device process flows. Hence, more robust, abundant and easily-deposited transparent conductor materials are being explored.

### SUMMARY OF THE INVENTION

The present invention describes nanostructure films. Nanostructures have attracted a great deal of recent attention due to their exceptional material properties. Nanostructures may include, but are not limited to, nanotubes (e.g., single-walled carbon nanotubes (SWNTs), multi-walled carbon nanotubes (MWNTs), double-walled carbon nanotubes (DWNTs), few-walled carbon nanotubes (FWNTs)), other fullerenes (e.g., buckyballs), graphene flakes/sheets, and/or nanowires (e.g., metallic (e.g., Ag, Ni, Pt, Au), semiconducting (e.g., InP, Si, GaN), dielectric (e.g., SiO₂,TiO₂), organic, inorganic). Nanostructure films may comprise at least one interconnected network of such nanostructures, and may similarly exhibit exceptional material properties. For example, nanostructure films comprising at least one interconnected network of substantially carbon nanotubes (e.g., wherein nanostructure density is above a percolation threshold) can exhibit extraordinary strength and electrical conductivity, as well as efficient heat conduction and substantial optical transparency. As used herein, “substantially” shall mean that at least 40% of components are of a given type.

In one embodiment, the nanostructure-film may substantially comprise carbon. As mentioned above, carbon nanostructures are a promising class of materials given their often-extraordinary mechanical, electrical and thermal properties.

In one embodiment of the present invention, the nanostructure film is patterned using an inert gas as an etching gas. As used herein, an “inert gas” is any gas, elemental or molecular, that is not significantly reactive under normal circumstances (e.g., noble gases). Additionally, an “inert gas” shall include certain so-called pseudo-inert gases, which are not usually considered inert but which behave like inert gases under given conditions (e.g., low pressure and/or plasma) and therefore can often be used inert gas substitutes in dry etching processes.

In one embodiment of the present invention, the nanostructure film is etched using an etching gas such as oxygen at atmospheric pressure.

In a further embodiment of the present invention, the nanostructure film may be etched using an etching gas such as oxygen at atmospheric pressure and at room temperature.

Other features and advantages of the invention will be apparent from the accompanying drawings and from the detailed description. One or more of the above-disclosed embodiments, in addition to certain alternatives, are provided in further detail below with reference to the attached figures. The invention is not limited to any particular embodiment disclosed; the present invention may be employed in not only transparent conductive film applications, but in other nanostructure applications as well (e.g., nontransparent electrodes, transistors, diodes, conductive composites, electrostatic shielding, etc.).

### BRIEF DESCRIPTION OF THE DRAWINGS

The invention is better understood from reading the following detailed description of the preferred embodiments, with reference to the accompanying figures in which:

FIG. 1 is a scanning electron microscope (SEM) image of a nanostructure film according to one embodiment of the present invention;

FIG. 2 is a schematic representation of a reactive ion etching (RIE) process and apparatus according to an embodiment of the present invention; and

FIG. 3 is a schematic process flow of a nanostructure-etching technique according to an embodiment of the present invention.

Features, elements, and aspects of the invention that are referenced by the same numerals in different figures represent the same, equivalent, or similar features, elements, or aspects in accordance with one or more embodiments of the system.

### DETAILED DESCRIPTION OF THE EMBODIMENTS

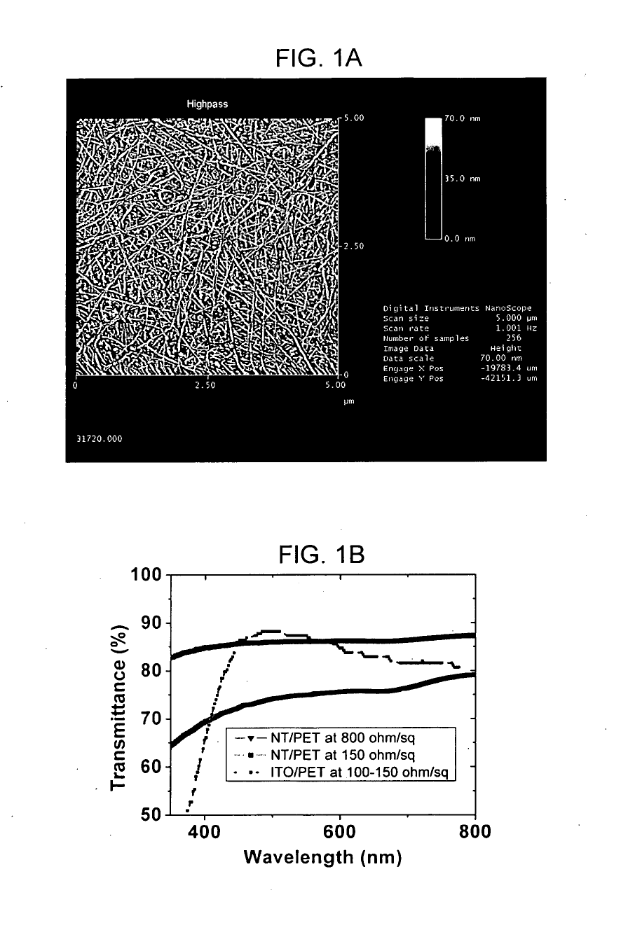

Referring to FIG. 1, a nanostructure film according to one embodiment of the present invention comprises at least one interconnected network of single-walled carbon nanotubes (SWNTs). Such film may additionally or alternatively comprise other nanotubes (e.g., MWNTs, DWNTs), other fullerenes (e.g., buckyballs), graphene flakes/sheets, and/or nanowires (e.g., metallic (e.g., Ag, Ni, Pt, Au), semiconducting (e.g., InP, Si, GaN), dielectric (e.g., SiO₂,TiO₂), organic, inorganic).

Such nanostructure film may further comprise at least one functionalization material bonded to the nanostructure film. For example, a dopant bonded to the nanostructure film may increases the electrical conductivity of the film by increasing carrier concentration. Such dopant may comprise at least one of Iodine (I₂), Bromine (Br₂), polymer-supported Bromine (Br₂), Antimonypentafluride (SbF₅), Phosphoruspentachloride (PCl₅), Vanadiumoxytrifluride (VOF₃), Silver(II)Fluoride (AgF₂), 2,1,3-Benzoxadiazole-5-carboxylic acid, 2-(4-Biphenylyl)-5-phenyl-1,3,4-oxadiazole, 2,5-Bis-(4-aminophenyl)-1,3,4-oxadiazole, 2-(4-Bromophenyl)-5-phenyl-1,3,4-oxadiazole, 4-Chloro-7-chlorosulfonyl-2,1,3-benzoxadiazole, 2,5-Diphenyl-1,3,4-oxadiazole, 5-(4-Methoxyphenyl)-1,3,4-oxadiazole-2-thiol, 5-(4-Methylphenyl)-1,3,4-oxadiazole-2-thiol, 5-Phenyl-1,3,4-oxadiazole-2-thiol, 5-(4-Pyridyl)-1,3,4-oxadiazole-2-thiol, Methyl viologen dichloride hydrate, Fullerene-C60, N-Methylfulleropyrrolidine, N,N′-Bis(3-methylphenyl)-N,N′-diphenylbenzidine, Triethylamine (TEA), Triethanolanime (TEA)-OH, Trioctylamine, Triphenylphosphine, Trioctylphosphine, Triethylphosphine, Trinapthylphosphine, Tetradimethylaminoethene, Tris(diethylamino)phosphine, Pentacene, Tetracene, N,N′-Di-[(1-naphthyl)-N,N′-diphenyl]-1,1′-biphenyl)-4,4′-diamine sublimed grade, 4-(Diphenylamino)benzaldehyde, Di-p-tolylamine, 3-Methyldiphenylamine, Triphenylamine, Tris[4-(diethylamino)phenyl]amine, Tri-p-tolylamine, Acradine Orange base, 3,8-Diamino-6-phenylphenanthridine, 4-(Diphenylamino)benzaldehyde diphenylhydrazone, Poly(9-vinylcarbazole), Poly(1-vinylnaphthalene), Poly(2-vinylpyridine)n-oxide, Triphenylphosphine, 4-Carboxybutyl)triphenylphosphonium bromide, Tetrabutylammonium benzoate, Tetrabutylammonium hydroxide 30-hydrate, Tetrabutylammonium triiodide, Tetrabutylammonium bis-trifluoromethanesulfonimidate, Tetraethylammonium trifluoromethanesulfonate, Oleum (H₂SO₄—SO₃), Triflic acid and/or Magic Acid.

Such dopant may be bonded covalently or noncovalently to the film. Moreover, the dopant may be bonded directly to the film or indirectly through and/or in conjunction with another molecule, such as a stabilizer that reduces desorption of dopant from the film. The stabilizer may be a relatively weak reducer (electron donor) or oxidizer (electron acceptor), where the dopant is a relatively strong reducer (electron donor) or oxidizer (electron acceptor) (i.e., the dopant has a greater doping potential than the stabilizer). Additionally or alternatively, the stabilizer and dopant may comprise a Lewis base and Lewis acid, respectively, or a Lewis acid and Lewis base, respectively. Exemplary stabilizers include, but are not limited to, aromatic amines, other aromatic compounds, other amines, imines, trizenes, boranes, other boron-containing compounds and polymers of the preceding compounds. Specifically, poly(4-vinylpyridine) and/or tri-phenyl amine have displayed substantial stabilizing behavior in accelerated atmospheric testing (e.g., 1000 hours at 65° C. and 90% relative humidity).

Stabilization of a dopant bonded to a nanostructure film may also or alternatively be enhanced through use of an encapsulant. The stability of a non-functionalized or otherwise functionalized nanostructure film may also be enhanced through use of an encapsulant. Accordingly, yet another embodiment of the present invention comprises a nanostructure film coated with at least one encapsulation layer. This encapsulation layer preferably provides increased stability and environmental (e.g., heat, humidity and/or atmospheric gases) resistance. Multiple encapsulation layers (e.g., having different compositions) may be advantageous in tailoring encapsulant properties. Exemplary encapsulants comprise at least one of a fluoropolymer, acrylic, silane, polyimide and/or polyester encapsulant (e.g., PVDF (Hylar CN, Solvay), Teflon AF, Polyvinyl fluoride (PVF), Polychlorotrifluoroethylene (PCTFE), Polyvinylalkyl vinyl ether, Fluoropolymer dispersion from Dupont (TE 7224), Melamine/Acrylic blends, conformal acrylic coating dispersion, etc.). Encapsulants may additionally or alternatively comprise UV and/or heat cross-linkable polymers (e.g., Poly(4-vinyl-phenol)).

Electronic performance of a nanostructure film according to one embodiment may additionally or alternatively be enhanced by bonding metal (e.g., gold, silver) nanoparticles to nanotubes (e.g., using electro and/or electroless plating). Such bonding may be performed before, during and/or after the nanotubes have formed an interconnected network.

A nanostructure film according to one embodiment may additionally or alternatively comprise application-specific additives. For example, thin nanotube films can be inherently transparent to infrared radiation, thus it may be advantageous to add an infrared (IR) absorber thereto to change this material property (e.g., for window shielding applications). Exemplary IR absorbers include, but are not limited to, at least one of a cyanine, quinone, metal complex, and photochronic. Similarly, UV absorbers may be employed to limit the nanostructure film's level of direct UV exposure.

A nanostructure film according to one embodiment may be fabricated using solution-based processes. In such processes, nanostructures may be initially dispersed in a solution with a solvent and dispersion agent. Exemplary solvents include, but are not limited to, deionized (DI) water, alcohols and/or benzo-solvents (e.g., tolulene, xylene). Exemplary dispersion agents include, but are not limited to, surfactants and biopolymers (e.g., carboxymethylcellulose (CMC)). Applicable surfactants may be non-ionic (e.g., Triton-X, alcohols, N,N-Dimethyl-N-[3-(sulfooxy)propyl]-1-nonanaminium hydroxide inner salt, N,N-Dimethyl-N-[3-(sulfooxy)propyl]-1-decanaminium hydroxide inner salt, Glycocholic acid hydrate, Chenodeoxycholic acid diacetate methyl ester, N-Nonanoyl-N-methylglucamine, Tetrabutylammonium nitrate, 3-(Decyldimethylammonio)-propane-sulfonate inner salt, 3-(N,N-Dimethyloctylammonio)propanesulfonate inner salt, EMPIGEN® BB detergent, 1-Dodecyl-2-pyrrolidinone), cationic (e.g., thonzonium bromide, cetyl trimethylammonium bromide (CTAB), benzyltrimethylammonium bromide (BTAB), behentrimonium chloride (BTAC), dodecyltrimethylammonium chloride surfactant (DTAC)), anionic (e.g., sodium dodecyl sulfate (SDS), sodium 1-decanesulfonate, sodium 1-dodecanesulfonate, sodium dodecylbenzenesulfonate (SDBS), sodium 1-heptanesulfonate) or Zwitterionic (e.g., Dodecyl betaine, Dodecyl dimethylamine oxide, Cocamidopropyl betaine, Coco ampho glycinate). It may be advantageous to employ a multiple-surfactant system, for example, mixtures of cationic and anionic surfactants or mixtures of nonionic and anionic surfactants. Dispersion may be further aided by mechanical agitation, such as by cavitation (e.g., using probe and/or bath sonicators), shear (e.g., using a high-shear mixer and/or rotor-stator), impingement (e.g., rotor-stator) and/or homogenization (e.g., using a homogenizer). Coating aids may also be employed in the solution to attain desired coating parameters, e.g., wetting and adhesion to a given substrate; additionally or alternatively, coating aids may be applied to the substrate. Exemplary coating aids include, but are not limited to, aerosol OT, fluorinated surfactants (e.g., Zonyl FS300, FS500, FS62A), alcohols (e.g., hexanol, heptanol, octanol, nonanol, decanol, undecanol, dodecanol, saponin, ethanol, propanol, butanol and/or pentanol), aliphatic amines (e.g., primary, secondary (e.g., dodecylamine), tertiary (e.g., triethanolamine), quartinary), TX-100, FT248, Tergitol TMN-10, Olin 10G and/or APG325.

The resulting dispersion may be coated onto a substrate using a variety of coating methods. Coating may entail a single or multiple passes, depending on the dispersion properties, substrate properties and/or desired nanostructure film properties. Exemplary coating methods include, but are not limited to, spray-coating, dip-coating, drop-coating and/or casting, roll-coating, transfer-stamping, slot-die coating, curtain coating, [micro]gravure printing, flexoprinting and/or inkjet printing. Exemplary substrates may be flexible or rigid, and include, but are not limited to, glass, elastomers (e.g., saturated rubbers, unsaturated rubbers, thermoplastic elastomers (TPE), thermoplastic vulcanizates (TPV), polyurethane rubber, polysulfide rubber, resilin and/or elastin) and/or plastics (e.g., polymethyl methacrylate (PMMA), polyolefin(s), polyethylene terephthalate (PET), polyethylene naphthalate (PEN), polycarbonate (PC), polyethersulfone (PES) and/or Arton). Flexible substrates may be advantageous in having compatibility with roll-to-roll (a.k.a. reel-to-reel) processing, wherein one roll supports uncoated substrate while another roll supports coated substrate. As compared to a batch process, which handles only one component at a time, a roll-to-roll process represents a dramatic deviation from current manufacturing practices, and can reduce capital equipment and product costs, while significantly increasing throughput. Nanostructure films may be printed first on a flexible substrate, e.g., to take advantage of roll-to-roll capabilities, and subsequently transferred to a rigid substrate (e.g., where the flexible substrate comprises a release liner, laminate and/or other donor substrate or adhesion layer (e.g., A-187, AZ28, XAMA, PVP, CX-100, PU)). Substrate(s) may be pre-treated to improve adhesion of the nanotubes thereto (e.g., by first coating an adhesion layer/promoter onto the substrate).

Once coated onto a substrate, the dispersion may be heated to remove solvent therefrom, such that a nanostructure film is formed on the substrate. Exemplary heating devices include a hot plate, heating rod, heating coil and/or oven. The resulting film may be washed (e.g., with water, ethanol and/or IPA) and/or oxidized (e.g., baked and/or rinsed with an oxidizer such as nitric acid, sulfuric acid and/or hydrochloric acid) to remove residual dispersion agent and/or coating aid therefrom.

Dopant, other additives and/or encapsulant may further be added to the film. Such materials may be applied to the nanostructures in the film before, during and/or after film formation, and may, depending on the specific material, be applied in gas, solid and/or liquid phase (e.g., gas phase NO₂ or liquid phase nitric acid (HNO₃) dopants). Such materials may moreover be applied through controlled techniques, such as the coating techniques enumerated above in the case of liquid phase materials (e.g., slot-die coating a polymer encapsulant).

A nanostructure film according to one embodiment may be patterned before (e.g., using lift-off methods, pattern-pretreated substrate), during (e.g., patterned transfer printing, screen printing (e.g., using acid-paste as an etchant, with a subsequent water-wash), inkjet printing) and/or after (e.g., using laser ablation or masking/etching techniques) fabrication on a substrate. Patterning may be effected by not only selective removal or coating of nanostructures, but additionally or alternatively by changing the material properties of the film (e.g., selectively rendering nanotubes non-conductive by exposing such nanotubes to electromagnetic radiation).

In one exemplary embodiment, an optically transparent and electrically conductive nanostructure film comprising an interconnected network of SWNTs was fabricated on a transparent and flexible plastic substrate via a multi-step spray and wash process. A SWNT dispersion was initially formulated by dissolving commercially-available SWNT powder (e.g., P3 from Carbon Solutions) in DI water with 1% SDS, and probe sonicated for 30 minutes at 300 W power. The resulting dispersion was then centrifuged at 10 k rcf (relative centrifugal field) for 1 hour, to remove large agglomerations of SWNTs and impurities (e.g., amorphous carbon and/or residual catalyst particles). In parallel, a PC substrate was immersed in a silane solution (a coating aid comprising 1% weight of 3-aminopropyltriethoxysilane in DI water) for approximately five minutes, followed by rinsing with DI water and blow drying with nitrogen. The resulting pre-treated PC substrate (Tekra 0.03″ thick with hard coating) was then spray-coated over a 100° C. hot plate with the previously-prepared SWNT dispersion, immersed in DI water for 1 minute, then sprayed again, and immersed in DI water again. This process of spraying and immersing in water may be repeated multiple times until a desired sheet resistance (e.g., film thickness) is achieved.

In a related exemplary embodiment, a doped nanostructure film comprising an interconnected network of SWNTs was fabricated on a transparent and flexible substrate using the methods described in the previous example, but with a SWNT dispersion additionally containing a TCNQF₄ dopant. In another related embodiment, this doped nanostructure film was subsequently encapsulated by spin-coating a layer of parylene thereon and baking.

In another exemplary embodiment, a SWNT dispersion was first prepared by dissolving SWNT powder (e.g., P3 from Carbon Solutions) in DI water with 1% SDS and bath-sonicated for 16 hours at 100 W, then centrifuged at 15000 rcf for 30 minutes such that only the top ¾ portion of the centrifuged dispersion is selected for further processing. The resulting dispersion was then vacuum filtered through an alumina filter with a pore size of 0.1-0.2 μm (Watman Inc.), such that an optically transparent and electrically conductive SWNT film is formed on the filter. DI water was subsequently vacuum filtered through the film for several minutes to remove SDS. The resulting film was then transferred to a PET substrate by a PDMS (poly-dimethylsiloxane) based transfer printing technique, wherein a patterned PDMS stamp is first placed in conformal contact with the film on the filter such that a patterned film is transferred from the filter to the stamp, and then placed in conformal contact with the PET substrate and heated to 80° C. such that the patterned film is transferred to the PET. In a related exemplary embodiment, this patterned film may be subsequently doped via immersion in a gaseous NO₂ chamber. In another related exemplary embodiment, the film may be encapsulated by a layer of PMPV, which, in the case of a doped film, can reduce desorption of dopant from the film.

In yet another exemplary embodiment, an optically transparent, electrically conductive, doped and encapsulated nanostructure film comprising an interconnected network of FWNTs was fabricated on a transparent and flexible substrate. CVD-grown FWNTs (OE grade from Unidym, Inc.) were first dissolved in DI water with 0.5% Triton-X, and probe sonicated for one hour at 300 W power. The resulting dispersion was then slot-die coated onto a PET substrate, and baked at about 100° C. to evaporate the solvent. The Triton-X was subsequently removed from the resulting FWNT film by immersing the film for about 15-20 seconds in nitric acid (10 molar). Nitric acid may be effective as both an oxidizing agent for surfactant removal, and a doping agent as well, improving the sheet resistance of the film from 498 ohms/sq to about 131 ohms/sq at about 75% transparency, and 920 ohms/sq to about 230 ohms/sq at 80% transparency in exemplary films. In related exemplary embodiments, these films were subsequently coated with triphenylamine which stabilized the dopant (i.e., the film exhibited a less than 10% change in conductivity after 1000 hours under accelerated aging conditions (65° C.)). In other related exemplary embodiments, the films were then encapsulated with Teflon AF.

In another exemplary embodiment, FWNT powder was initially dispersed in water with SDS (e.g., 1%) surfactant by sonication (e.g., bath sonication for 30 minutes, followed by probe sonication for 30 minutes); 1-dodecanol (e.g., 0.4%) was subsequently added to the dispersion by sonication (e.g., probe sonication for 5 minutes) as a coating aid, and the resulting dispersion was Meyer rod coated onto a PEN substrate. SDS was then removed by rinsing the film with DI water, and the 1-dodecanol was removed by rinsing with ethanol. This resulting optically transparent and electrically conductive films passed an industry-standard “tape test,” (i.e., the FWNT film remained on the substrate when a piece of Scotch tape was pressed onto and then peeled off of the film); such adhesion between the FWNT film and PEN was not achieved with SDS dispersions absent use of a coating aid.

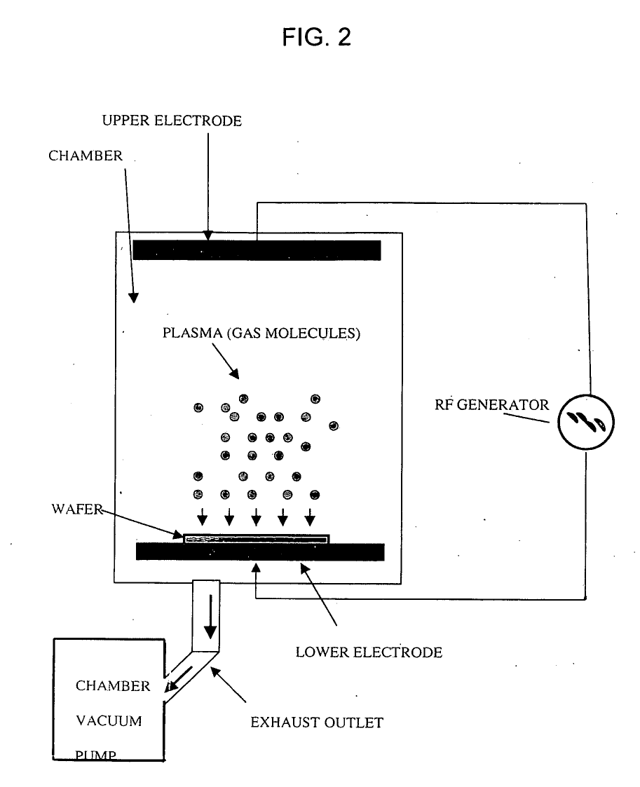

In one exemplary embodiment, a carbon nanotube film was patterned by dry etching with an inert gas. Referring to FIG. 2, one common dry-etching process is reactive ion etching (RIE), wherein gas flow is introduced through small inlets in the top of a vacuum chamber and plasma is initiated in the low-pressure system through the application of radio frequency (RF) power. Etching occurs when the plasma ions react chemically with the surface of a sample and/or physically etch said surface due to the ions' high kinetic energies. The types and amounts of gases used are determined by the etch process-conventional etch gases are usually oxygen (e.g., for etching of photoresists and polyimide) or fluorine and/or chlorine-based (e.g., for etching semiconductors and some metals). Inert gases are used in dry etching generally only as dilutants rather than etchants, since such gases do not react significantly with most integrated-circuit (IC) materials. However, as employed in the present invention, such gases (e.g., argon (Ar), helium (He), neon (Ne), krypton (Kr), etc.) can be employed as effective etch gases (e.g., for carbon), and are advantageous over many other dry etching processes (e.g., oxygen (O2) plasma) in that they can allow high selectivity control between, for example, carbon nanostructures (e.g., nanotubes) and passivation materials such as silicon nitride (SiNx:H), silicon dioxide (SiO2), amorphous silicon (a-Si:) and poly-silicon (poly-Si). For example, in a nanostructure TFT LCD fabrication process, a nanostructure-film may be patterned into electrodes without undesired etching of the dielectric and semiconductor layers. Moreover, the use of inert gas plasmas can avoid the undesirable etch residue-induced contamination, halogen polymer residues, and/or corrosion species caused by many fluorine (F) and chlorine (Cl) induced plasma etching processes.

In one exemplary embodiment, a carbon nanotube film comprising substantially SWNTs was deposited onto an SiO₂ substrate using a spray method as described above. This film was placed in a dry-etching apparatus (e.g., an Oxford Reactive Ion Etcher (RIE)), and therein exposed to an inert gas plasma (e.g., 100% argon at 100 W power, 100 mTorr pressure and gas flow rate of ˜1000 sccm) with half of the substrate covered with a glass plate. After only a relatively brief exposure time (e.g. ˜5 minutes), the nanostructure-film coating the non-glass-covered portion of the nanostructure-coated substrate was almost completely removed (e.g., four-point probe measurements in that region indicated zero electrical conductivity, as is to be expected from bare SiO2). On the other hand, the glass-covered portion of the nanostructure-coated substrate exhibited an electrical conductivity indicative of a carbon nanotube film (e.g. ˜1000 S/cm). Additionally, as predicted, previously-exposed and non-glass-covered portions of the SiO2 substrate were not visibly affected by exposure to the inert gas plasma.

In one embodiment, a nanostructure film is etched using an etching gas such as oxygen at atmospheric pressure. In a further embodiment, the nanostructure film is etched using an etching gas such as oxygen at both atmospheric pressure and room temperature. As described above, dry etching of IC components is usually performed at low (i.e., substantially below-atmospheric) pressures and/or elevated temperatures.

In one exemplary embodiment, plasma may be generated by application of an electrical field to a gas, such as oxygen. Whereas it is relatively easy to generate plasma in a vacuum chamber, where the ions and electrons have long lifetimes, at atmospheric pressure, atoms and radicals are quickly consumed by collisions in the gas, so the transit time from the plasma to the nanostructure film must be short, and a significant challenge in generating atmospheric plasma for nanostructure-film etching is designing the electrodes and gas flow to yield intimate contact between the reactive gases and the nanostructure film. In exemplary experiments, a 1% oxygen in argon gas mixture may be fed into an atmospheric plasma etcher (e.g., a Surfx Atomoflo etcher, tuned to etch thin films comprising interpenetrated networks of carbon nanotubes on flexible plastic substrates) to etch a nanostructure film passing thereunder on a roll-to-roll apparatus.

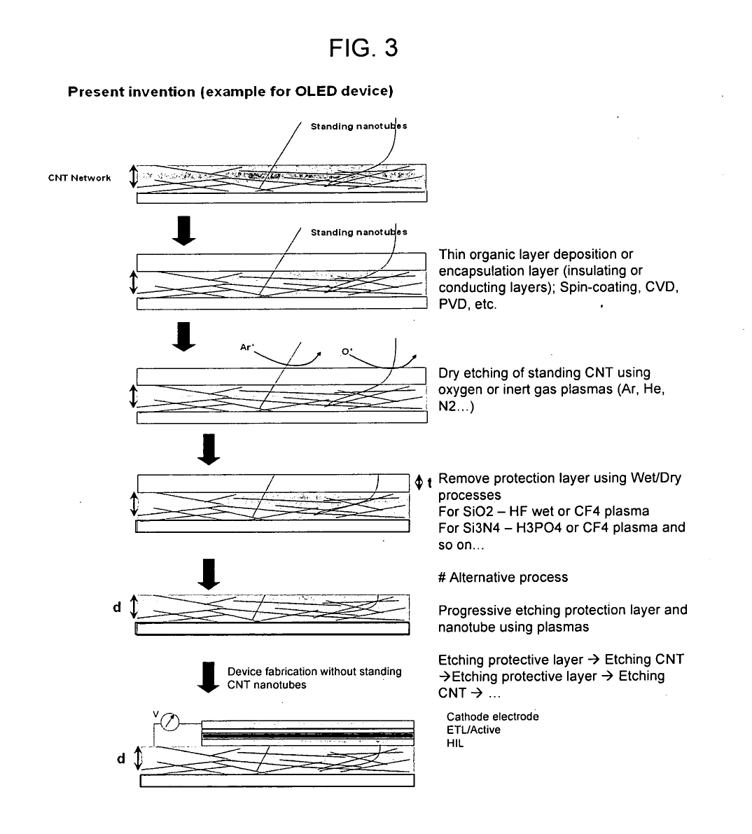

Referring to FIG. 3, in one embodiment, the plasma etching methods described above may be employed to selectively etch nanostructures protruding from a nanostructure film. For example, in a device (e.g., OLED, thin film solar cell, EL lamp, display, thin-film transistor) wherein an active and/or other device layer is sandwiched between two device electrodes, at least one of which comprises a nanostructure film, the plasma etching methods of the present invention may be used to prevent penetration of the usually-thin active layer and/or other device layer (e.g., buffer layers (HIL, ETL), semiconducting channel) by nanostructures protruding from adjacent nanostructure film(s); such penetration can result in decreases in device performance (e.g., due to short-circuiting (shorting) of the device).

In an exemplary embodiment, a (e.g., several-nanometers-thick) protection layer is deposited over an underlying nanostructure film, such that only protruding nanostructures (e.g., those extending further from the film than the thickness of the protection layer) remain exposed. The protection layer may be, for example, an inorganic material and/or encapsulant, and may be deposited by known-techniques such as spin-coating, chemical vapor deposition (CVD), physical vapor deposition (PVD), etc. This protection layer is preferably thinner than a corresponding later-deposited active and/or other active layer(s) (e.g., buffer layers, semiconducting channel). The exposed protruding nanostructures may then be etched, for example using an inert gas dry etching process as described above. The protection layer may be removed once exposed nanostructures protruding therefrom have been etched away. The protection layer may be removed in one step or may be removed progressively. Where the protection layer is removed progressively (e.g., in multiple steps), additional nanostructure etching steps may be incorporated between protection layer removal steps, such that nanostructures protruding through the protection layer are substantially etched away (e.g., etch away a portion of the protection layer, etch newly exposed nanostructure segments, etch away another portion of the protection layer, etch newly exposed nanostructure segments, etc.). Preferably, dry etching is used for progressive protection layer removal, however, wet processes may also or alternatively be employed. For example, HF and/or CF4 plasma may be used to strip an SiO2 protection layer; and H3PO4 and/or CF4 plasma may be used to strip an Si3N4 protection layer. The resulting nanostructure films are preferably substantially planar, such that active and/or other device layers (e.g., buffer layers, semiconducting channel) may be deposited thereon with decreased penetration by standing or otherwise protruding nanostructures. These results may be achieved through use of protection layers that are substantially thinner than corresponding, later-deposited active and/or other device layers, such that unetched portions of nanostructures from within the protective layer will not be long enough to fully penetrate the entire thickness of the active and/or other device layers. Additionally or alternatively, these results may be achieved through progressive etching of protruding nanotubes and protection layers as described above.

The present invention has been described above with reference to preferred features and embodiments. Those skilled in the art will recognize, however, that changes and modifications may be made in these preferred embodiments without departing from the scope of the present invention.

What is claimed is:

1. A method of patterning a nanostructure film on a substrate, comprising applying a plasma to the nanostructure film, such that the plasma removes a select portion of the nanostructure film from the substrate.

2. The method of claim 1, wherein the nanostructure film substantially comprises carbon nanotubes.

3. The method of claim 2, wherein the plasma comprises an inert gas.

4. The method of claim 3, wherein the inert gas etches the nanostructure film.

5. The method of claim 4, wherein the inert gas is at least one of He, Ne, Ar and Kr and Xe.

6. The method of claim 1, wherein the nanostructure film substantially comprises carbon.

7. The method of claim 6, wherein the plasma consists of an inert gas.

8. The method of claim 7, wherein the inert gas is at least one of He, Ne, Ar and Kr and Xe.

9. The method of claim 8, wherein the nanostructure film comprises carbon nanotubes.

10. The method of claim 1, wherein the plasma consists of an inert gas.

11. The method of claim 1, wherein the nanostructure film substantially comprises carbon.

12. The method of claim 11, wherein the plasma is applied to the nanostructure film at atmospheric pressure.

13. The method of claim 12, wherein the plasma is applied to the nanostructure-film at near room temperature.

14. The method of claim 13, wherein the plasma comprises oxygen.

15. The method of claim 14, wherein the nanostructure film comprises carbon nanotubes.

16. A method of patterning a carbon nanotube film, comprising applying a plasma to the carbon nanotube film, wherein the plasma removes a portion of the carbon nanotube film.

17. The method of claim 16, wherein the plasma is applied to the film at room temperature.

18. The method of claim 17, wherein the plasma is applied to the film at atmospheric pressure.

19. The method of claim 16, wherein the plasma consists of an inert gas.

20. The method of claim 19, wherein the inert gas is Ar.
